(19) United States
(12) Patent Application Publication
(10) Pub. No.: US 2012/0086367 A1
(43) Pub. Date: Apr. 12, 2012

(54) ACTUATING DEVICE, MICROSYSTEM DEVICE, AND METHOD FOR CONTROLLING A MICROMECHANICAL ACTUATOR

(76) Inventors: Mohamad IYAD AL DIBS, Pfullingen (DE); Axel WENZLER, Rottweil (DE)

(21) Appl. No.: 13/247,510

(22) Filed: Sep. 28, 2011

(30) Foreign Application Priority Data
Oct. 7, 2010 (DE) 10 2010 042 119.7

(51) Int. Cl. H02N 1/00

(52) U.S. Cl. 318/116

(57) ABSTRACT

A method, actuating device, and microsystem device are described for controlling a micromechanical actuator, which has a rechargeable capacitor for generating a mechanical motion of the micromechanical actuator, a memory having a lookup table containing previously computed data of signal shapes for controlling the micromechanical actuator, and a driver circuit having a driver circuit control unit for processing the previously computed data, a power stage for generating the signal shapes, and an output for outputting the signal shapes, corresponding to previously computed data, to the micromechanical actuator's rechargeable capacitor. The micromechanical actuator has a limiting device, between the output of the driver circuit and the micromechanical actuator, which is for limiting a voltage excursion of the signal shapes output by the driver circuit, which are usable for generating the mechanical motion by recharging the micromechanical actuator's rechargeable capacitor. The micromechanical actuator's power consumption is reducible by limiting the voltage excursion.

### FIELD OF THE INVENTION

The present invention relates to an actuating device, a microsystem device, and a method for controlling a micromechanical actuator.

### BACKGROUND INFORMATION

In general, a microsystem, also referred to below as a microelectromechanical system (MEMS), includes one or multiple sensors, micromechanical actuators, and an associated control electronics system, which are integrated on a carrier substrate or a chip. The integrated control electronics system generally uses either strictly linear drivers or strictly digital drivers.

The presentation by Veljko Milanović titled “Linearized Gimbal-less Two-Axis MEMS Mirrors” at the Optical Fiber Communication Conference and Exposition in San Diego, Calif., on Mar. 25, 2009 discusses a biaxial MEMS scanning mirror without the use of a cardanic suspension. This MEMS scanning mirror reportedly offers rapid scanning, with low power consumption, in an angular range of up to 32° on both axes; the MEMS scanning mirror loses less than 1 mW light power as the result of spatial misdeflections. A linear driver control and a four-quadrant addressable design reportedly allow a practically linear voltage-angle characteristic of the MEMS scanning mirror. The MEMS system is made entirely of a silicon monocrystal, which is used as a substrate and also for the electronic and mechanical components of the MEMS scanning mirror.

HiperScan GmbH, 01109 Dresden, Germany, discusses in a Jan. 30, 2009 press release a micro-scanning mirror made of small silicon chips based on MEMS-based microsystems. This micro-scanning mirror may have a diameter of between 0.5 mm and 3 mm, and is pivotable in an optical range of 16° to 80° at mechanical resonance frequencies between 150 Hz and 32 kHz. In the system, a digitally controlled driver circuit is used as a control circuit of the control electronics system for the micro-scanning mirror.

Micromechanical actuators of an MEMS-based microsystem have multiple resonance points in their mechanical oscillation spectrum, so-called modes, which may be excited with the aid of appropriate electrical signals. The modes of the micromechanical actuators are divided into useful modes and spurious modes. The excitation of spurious modes impairs the functionality of MEMS-based microsystems.

From a mechanical standpoint, a micromechanical actuator is an inert spring-mass system which forms a harmonic oscillator, and which may be modeled using a spring having a weight affixed thereto. However, due to the usual design of the actual micromechanical actuator in the form of a miniature bar, and on account of other deviations such as the nonlinearity of the system, actual micromechanical actuators have multiple resonance points. The base frequency of the micromechanical actuator is defined by the first mode which appears in the frequency spectrum.

Therefore, in principle it is possible to operate the micromechanical actuators of the MEMS in resonance on one or multiple useful modes. A prerequisite for effectively controlling the resonances of the micromechanical actuator is to excite only the desired useful mode or useful resonance point, and to encounter no spurious mode. Alternatively, the MEMS may be operated mechanically in a quasi-steady state manner. In this type of operation, no individual modes of the micromechanical actuator are to be excited. For linear control, the MEMS element is generally operated in a quasi-steady state manner.

In an integrated linear driver, control of the application-specific integrated circuit (ASIC) requires a comparatively large surface area for integrating operational amplifiers, regulators, voltage and current reference circuits, stabilizing capacitors, and other electronic units. The signal shapes to be used for deflecting the micromechanical actuators are usually digitally stored in a memory or in a lookup table (LT) in the ASIC. Therefore, the use of linear drivers requires the implementation of digital-analog converters in order to convert quantized digital signals or individual values into analog signals. Since the current consumption and space requirements of the digital-analog converters increase in direct proportion to the signal bandwidth and signal accuracy, the overall MEMS system is complex and expensive to implement, requires a large total surface area, and has high power consumption. In addition, the space requirements increase as the result of further reference circuits, driver circuits, and regulation and control circuits. This simple example illustrates the complexity present in the ASIC in order to provide a desired signal for the actuator.

The use of digital drivers is simpler and consumes less space. However, when digital drivers are used, the reactive power delivered to the micromechanical actuator of the MEMS increases linearly as a function of frequency f and increases as a function of the square of the voltage according to the following expression, which applies for received reactive power P of the micromechanical actuator, which has a capacitance C and is controlled by voltage U:

P=0.5×U²×C×f

If the digital output stages are dimensioned in such a way that they meet the stringent demands on the signal shapes which they output with regard to the reactive power to be delivered, the bandwidth, and accuracy, the digital output stages, due to their complicated design, require a large space for the integration and high current consumption of the integrated circuit. Because of the high frequencies contained in the signal shapes for the control, spurious modes of the micromechanical actuator are often inadvertently excited, also in the case of pure quasi-steady state operation of the micromechanical actuator.

### SUMMARY OF THE INVENTION

The exemplary embodiments and/or exemplary methods of the present invention provide an actuating device which is designed to control a micromechanical actuator having the features described herein, a microsystem device which includes a micromechanical actuator having the features described herein, and a method for controlling the micromechanical actuator having the features described herein.

According to the exemplary embodiments and/or exemplary methods of the present invention, a combination of a linear driver circuit and a digital driver circuit is used for controlling and deflecting a micromechanical actuator with the aid of a limiting device, an actuating device being used which is designed to control a micromechanical actuator which has a rechargeable capacitor for generating a mechanical motion of the micromechanical actuator, the actuating device having a memory which has a lookup table containing previously computed data of signal shapes for controlling the micromechanical actuator; and having a driver circuit which has a driver circuit control unit for processing the previously computed data, a power stage for generating the signal shapes, and an output for outputting the signal shapes, corresponding to the previously computed data, to the rechargeable capacitor of the micromechanical actuator. The actuating device according to the present invention also includes a limiting device, situated between the output of the driver circuit and the micromechanical actuator, which is designed for limiting a voltage excursion of the signal shapes output by the driver circuit, which are usable for generating the mechanical motion by recharging the rechargeable capacitor of the micromechanical actuator, the power consumption of the micromechanical actuator being reducible by limiting the voltage excursion.

Moreover, the exemplary embodiments and/or exemplary methods of the present invention relate to a microsystem device which includes a micromechanical actuator which has a rechargeable capacitor for generating a mechanical motion of the micromechanical actuator, the microsystem device having a memory which has a lookup table containing previously computed data of signal shapes for controlling the micromechanical actuator, and having a driver circuit which has a driver circuit control unit for processing the previously computed data, a power stage for generating the signal shapes, and an output for outputting the signal shapes, corresponding to the previously computed data, to the rechargeable capacitor of the micromechanical actuator.

The microsystem device according to the present invention also includes a limiting device, situated between the output of the driver circuit and the micromechanical actuator, which is designed for limiting a voltage excursion of the signal shapes output by the driver circuit, which are usable for generating the mechanical motion by recharging the rechargeable capacitor of the micromechanical actuator, the power consumption of the micromechanical actuator being reducible by limiting the voltage excursion.

Moreover, the exemplary embodiments and/or exemplary methods of the present invention relate to a method for controlling a micromechanical actuator which has a rechargeable capacitor for generating a mechanical motion of the micromechanical actuator, the method including outputting signal shapes to the rechargeable capacitor of the micromechanical actuator, a driver circuit for controlling the micromechanical actuator having a memory which has a lookup table containing previously computed data of signal shapes for controlling the micromechanical actuator, and a driver circuit control unit, a power stage for generating the signal shapes, and an output for outputting the signal shapes, corresponding to the previously computed data, to the rechargeable capacitor of the micromechanical actuator. The method also includes limiting power consumption of the micromechanical actuator, whereby a limiting device, situated between the output of the driver circuit and the micromechanical actuator, limits a voltage excursion of the signal shapes output by the driver circuit, the signal shapes being used for generating the mechanical motion by recharging the rechargeable capacitor of the micromechanical actuator.

### SUMMARY OF THE INVENTION

An advantage of the exemplary embodiments and/or exemplary methods of the present invention are a smaller space requirement of the circuit of the overall MEMS system due to a simple design of the application-specific integrated circuit of the digital output stage of the MEMS, and due to low power loss of the overall MEMS system. The power loss is reduced by using a limiting device which is inserted into the circuit between the output of the digital output stage and the micromechanical actuator. The limiting device may be easily implemented using different methods and various circuit designs.

An aspect of the exemplary embodiments and/or exemplary methods of the present invention lies in limitation by appropriately limiting maximum voltage excursion ΔU_{c} at the capacitor of the micromechanical actuator to be recharged. At a supply voltage of 100 V and using the limiting device, maximum voltage excursion ΔU_{c} is normally in the range of 2 V to 10 V, and no longer at 100 V. The resulting power loss in the micromechanical actuator may be computed from capacitor C_{actuator} based on two components. The first component is computed based on small maximum voltage excursion ΔU_{c} and a high frequency f_{fast} of approximately 80 kHz. The second component is computed based on voltage U_{VDD} and slow frequency f_{slow} of approximately 60 Hz. The overall power loss using hybrid drive P_{actuator hybrid} is thus an order of magnitude less than when a digital driver approach is used.

Likewise, the power consumption in the ASIC for the hybrid drive according to the present invention is comparable to the consumption when a digital driver is used, and is much less than the power consumption when a linear driver is used.

The limiting device should be designed in such a way that the signal at the output of the control circuit of the micromechanical actuator has only two frequency components. The first frequency component is frequency f_{slow} of approximately 60 Hz, via which the actuator is controlled. Second frequency component f_{fast} of approximately 80 KHz is to be designed in such a way that the micromechanical actuator has no spurious modes in this frequency range which are excited by the second frequency component. The inertia of the mass of the micromechanical actuator ensures that frequency component f_{fast} is damped during the mechanical deflection.

The further descriptions herein contain advantageous refinements of and improvements on the particular subject matter of the present invention.

According to one refinement, the limiting device of the actuating device is implemented by one or multiple ohmic resistors connected in series. For example, a 1-MΩ or 3-MΩ ohmic series resistor is used for limiting the voltage applied to the micromechanical actuator.

According to another refinement, the limiting device of the actuating device is implemented by a current mirror circuit of the driver circuit. For example, a current mirror circuit is used as a subcircuit of the driver circuit, which allows the current through the micromechanical actuator to be scaled, and thus limited in a controlled manner.

According to another refinement, the limiting device of the actuating device is implemented by a simple low-pass filter.

According to another refinement, the limiting device is designed for limiting a voltage of the signal shapes applied to the micromechanical actuator.

According to another refinement, the limiting device is designed for limiting a current of the signal shapes applied to the micromechanical actuator.

According to another refinement, the driver circuit has a pulse width modulation device which generates a pulse width modulation signal for controlling the micromechanical actuator.

According to another refinement, the pulse width modulation of the driver circuit is designed in a frequency range which is so much higher than frequencies of mechanical resonances of the micromechanical actuator that inertia of the micromechanical actuator prevents mechanical motions of the micromechanical actuator in the frequency range of the pulse width modulation.

According to another refinement of the method, the driver circuit of the actuating device is controlled by pulse width modulation for controlling the micromechanical actuator.

According to another refinement of the method, the pulse width modulation of the driver circuit is operated in a frequency range which is so much higher than frequencies of mechanical resonances of the micromechanical actuator that inertia of the micromechanical actuator prevents mechanical motions of the micromechanical actuator in the frequency range of the pulse width modulation.

The present invention is explained in greater detail below with reference to the exemplary embodiments illustrated in the schematic figures.

### BRIEF DESCRIPTION OF THE DRAWINGS

FIG. 1 shows a schematic block diagram of a microsystem device for controlling a micromechanical actuator, together with a limiting device, according to one specific embodiment of the present invention.

FIG. 2 shows a schematic block diagram of a microsystem device for controlling a micromechanical actuator, together with a series resistor, according to another specific embodiment of the present invention.

FIG. 3 shows a schematic block diagram of a microsystem device for controlling a micromechanical actuator, together with a current mirror circuit, according to another specific embodiment of the present invention.

FIG. 4 shows a schematic block diagram of a microsystem device for controlling a micromechanical actuator, together with a cascode current mirror circuit, according to another specific embodiment of the present invention.

FIG. 5 shows a schematic block diagram of the microsystem device for controlling a micromechanical actuator, together with a first low-pass circuit, according to another specific embodiment of the present invention.

FIG. 6 shows a schematic block diagram of the microsystem device for controlling a micromechanical actuator, together with a second low-pass circuit, according to another specific embodiment of the present invention.

FIG. 7 shows a block diagram of an equivalent circuit diagram of a micromechanical actuator as an example.

FIG. 8 shows a function graph of a signal shape for controlling a micromechanical actuator 2 according to another specific embodiment of the present invention.

FIG. 9 shows a function graph of a signal shape for controlling a micromechanical actuator 2 according to another specific embodiment of the present invention.

FIG. 10 shows a cross section of an electrostatically excitable micromechanical actuator according to another specific embodiment of the present invention.

FIG. 11 shows a flow chart of a method for controlling a micromechanical actuator according to another specific embodiment of the present invention.

### DETAILED DESCRIPTION

Before the figures of the drawings are described, basic relationships are discussed at first to enable a clear description of the exemplary embodiments illustrated in the figures of the drawings.

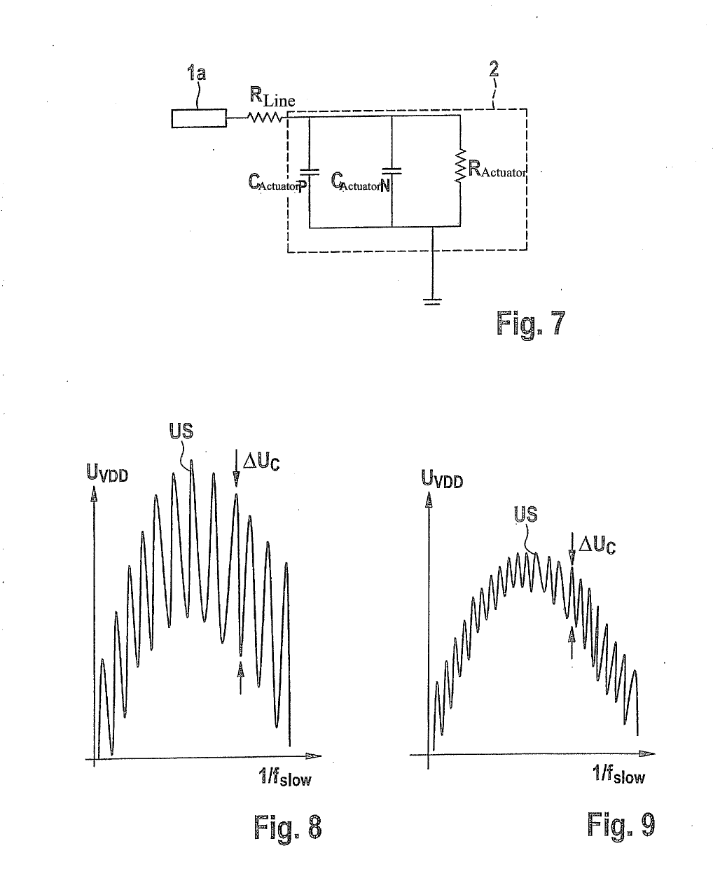

A micromechanical actuator of an MEMS-based microsystem may be modeled as a high-resistance resistor R_{actuator} and a capacitor C_{actuator} parallel thereto, as discussed below in the description of FIG. 7. A relatively low-resistance series resistor Rₗᵢₙₑ represents all line resistors. Capacitor C_{actuator} includes a parasitic capacitor C_{actuator P} and a useful capacitor C_{actuator N}. Useful capacitor C_{actuator N}, which is directly related to the mechanical deflection of the micromechanical actuator, is often small compared to parasitic capacitor C_{actuator P}. The value of the useful capacitance of a micromechanical actuator is dynamically changeable, and may drop to near 0 F in particular in the event of damage to the micromechanical actuator. Independently thereof, capacitor C_{actuator} is continuously recharged during the electrical control of the micromechanical actuator, and thus generates reactive power P_{actuator} to be applied by the control circuit. Typical values of C_{actuator} are in the range of 20 pF to 245 pF.

When the micromechanical actuator is controlled using a dynamically changeable signal, overall capacitor C_{actuator}=C_{actuator P}+C_{actuator N} must be recharged. Reactive power P_{actuator} actuator of the micromechanical actuator is determined as follows:

P_{actuator}=U₂÷R_{actuator}+0.5×U²×F×(C_{actuator N}+C_{actuator P})

When a linear driver is used for controlling and deflecting a micromechanical actuator, overall capacitor C_{actuator} of the micromechanical actuator, which includes the useful capacitor and the parasitic capacitor, is recharged at a frequency f_{slow} of 60 Hz, for example, and a voltage U_{VDDA} of approximately 100 volts. The power required is as follows:

P_{actuator-linear}=U_{VDDA}²÷R_{actuator}+0.5×U_{VDDA}²×f_{slow}×(C_{actuator N}+C_{actuator P})

Use of strictly digital drivers entails the risk that one or multiple spurious modes may be excited, so that the micromechanical actuator is operable only in an unstable manner. To avoid exciting the spurious mode of the micromechanical actuator, a modulation is selected, such as a pulse width modulation (PWM) or an undershooting method, for example, as a type of modulation in an almost mode-free frequency range of the micromechanical actuator. In pulse width modulation, the electrical voltage alternates between two values at a high frequency f_{fast}, for example 80 KHz, a motion of the micromechanical actuator at this high frequency f_{fast} being avoided by making use of the mechanical inertia of the micromechanical actuator, which has mass. However, this results in an increase in the reactive power which is output at the capacitor of the micromechanical actuator, and in the requirement for steepness at the circuit of the output stage of the digital driver.

R_{actuator-digital}=U_{VDDA}²÷R_{actuator}+0.5×U_{VDDA}²×f_{fast}×(C_{actuator N}+C_{actuator})

Similar or functionally equivalent components are denoted by the same reference numerals in the figures.

FIG. 1 shows a schematic block diagram of an actuating device 1 for controlling a micromechanical actuator 2 according to one specific embodiment of the present invention. Actuating device 1 includes a driver circuit 4 and a limiting device 8 for controlling micromechanical actuator 2. Micromechanical actuator 2 is designed, for example, as a free-standing metal-plated miniature tongue made of silicon oxide, or as some other insulator having metal electrodes mounted on the sides, the miniature tongue being deflected by electrostatically acting forces when a control voltage is applied to the metal electrodes. Micromechanical actuator 2 may also be designed as piezoelectric converters in the form of a piezocrystal or a piezoelectric ceramic. Changes in length in the nm to μm range may be achieved as a result of the electrical fields in the kV/m range which are generated at electrodes of the piezoelectric converter, when the piezocrystal or the piezoelectric ceramic has an appropriate size. The mechanical actuation of micromechanical actuator 2 is gradually controllable via the voltage present at the piezocrystal.

Driver circuit 4 of actuating device 1 is implemented, for example, using a driver circuit control unit 5 and a power stage 6 which includes two metal oxide semiconductor field effect transistors, and also has an output 7 which outputs a voltage signal US of actuating device 1, and which is connected to a limiting device 8 of actuating device 1 in order to control micromechanical actuator 2. For example, in one specific embodiment of actuating device 1, lookup table LT is connected to driver circuit control unit 5, which controls power stage 6 at its input side via two outputs. Power stage 6 is connected at its output side to output 7 of driver circuit 4.

Actuating device 1 has a data structure in a lookup table LT which contains previously computed data of signal shapes for controlling micromechanical actuator 2. The previously computed data allow computation of suitable signal shapes and signal curves for micromechanical actuator 2. These signal shapes and signal curves are output in a simple manner by driver circuit control unit 5 and power stage 6. A lookup table LT is filled with data points of signal curves or signal shapes which are to be applied by driver circuit control unit 5 in order to obtain the desired deflection of micromechanical actuator 2, taking the resonance modes thereof into account. Driver circuit control unit 5 of driver circuit 4 computes the signal shapes based on the stored data points in lookup table LT. Limiting device 8 of actuating device 1 may be designed as a voltage or current limiter and used for regulating or limiting electrical voltages or currents. Stabilizer circuits, for example, are also used as limiting device 8, and hold constant or limit the voltage present at micromechanical actuator 2 up to a certain maximum current.

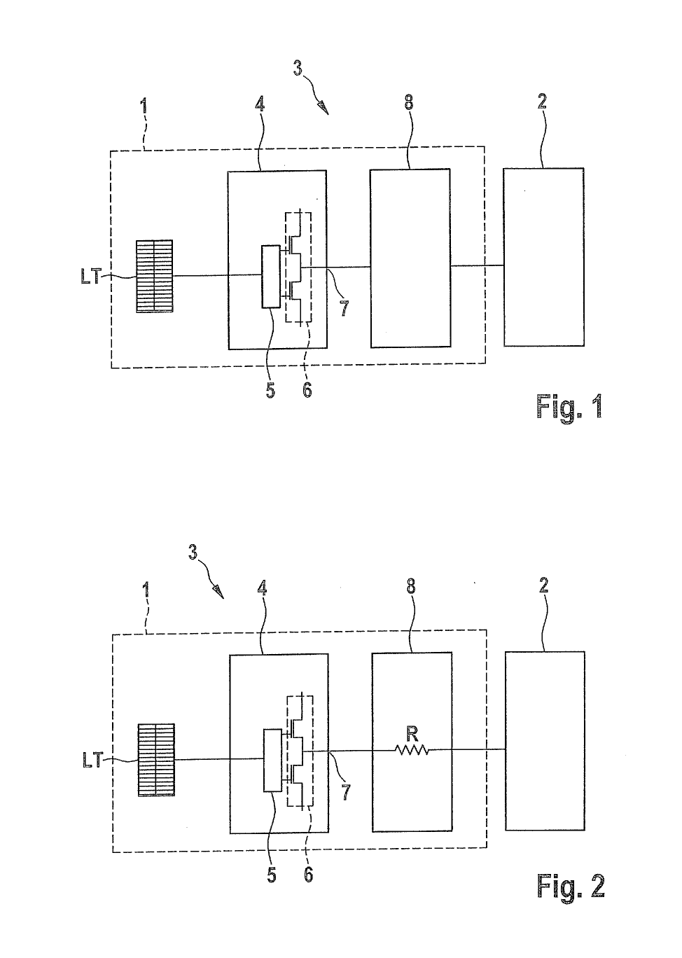

FIG. 2 shows a schematic block diagram of actuating device 1 for controlling micromechanical actuator 2, together with a series resistor, according to another specific embodiment of the present invention. For example, limiting device 8 of actuating device 1 is designed in the form of an ohmic resistor R, which on the one hand is connected directly to output 7 of driver circuit 4, and on the other hand is connected to micromechanical actuator 2. Ohmic resistor R is, for example, an ohmic resistor having a nominal value of 1 MΩ or 3 MΩ. Limiting device 8 of actuating device 1 may also be implemented by using multiple resistors having different nominal values. Driver circuit 4 includes a driver circuit control unit 5 and a power stage 6, for example.

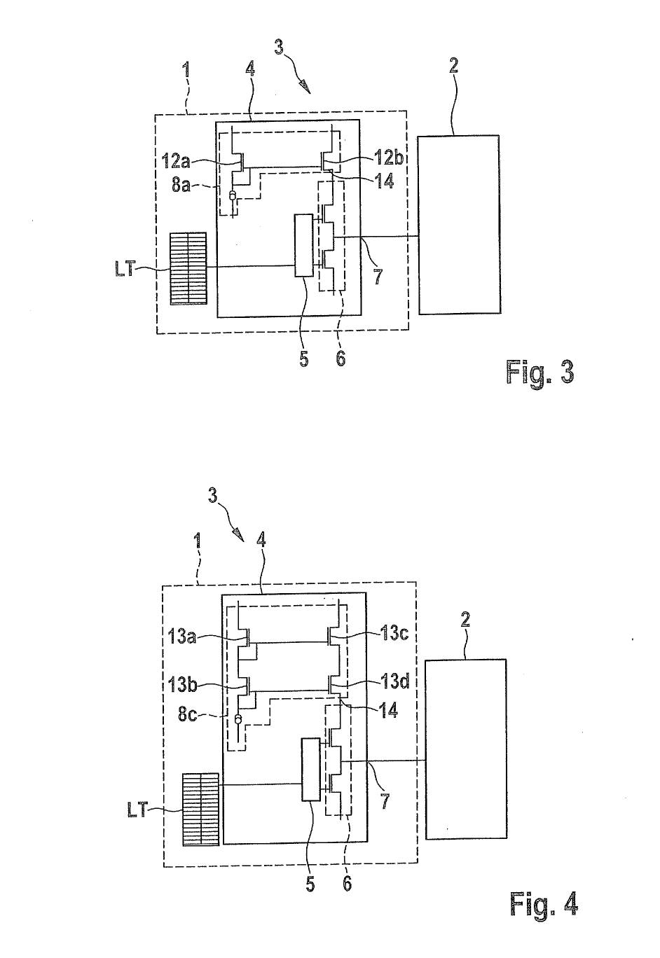

FIG. 3 shows a schematic block diagram of actuating device 1 for controlling micromechanical actuator 2, together with a current mirror circuit 8b, according to another specific embodiment of the present invention. Simple current mirror circuit 8b is designed, for example, having two transistors, two bipolar transistors, or two metal oxide semiconductor field effect transistors 12a and 12b. In a first metal oxide semiconductor field effect transistor 12a, the drain and the control electrode are connected to one another and electrically short-circuited. In addition, a voltage source is connected at the drain of first metal oxide semiconductor field effect transistor 12a. When a source-drain current flows through first metal oxide semiconductor field effect transistor 12a, a control electrode source voltage results which is linked to the source-drain current. The control electrodes of the two metal oxide semiconductor field effect transistors 12a and 12b are connected, so that the same control electrode source voltage is present at both metal oxide semiconductor field effect transistors 12a and 12b. Second metal oxide semiconductor field effect transistor 12b is connected at its drain to power stage 6. Thus, the source-drain current of second metal oxide semiconductor field effect transistor 12b is likewise a function of the shared control electrode source voltage, and only the ratio of the output characteristic curves of the two metal oxide semiconductor field effect transistors 12a and 12b determines the ratio of the particular source-drain currents of the two metal oxide semiconductor field effect transistors 12a and 12b. The current mirror is used, for example, as a current-controlled current source; i.e., a constant multiple of the internal source-drain current flowing through first metal oxide semiconductor field effect transistor 12a is obtained at output 14 of current mirror circuit 8b. As a result of the constant source-drain current, current mirror circuit 8b is used as a constant power source for power stage 6, and thus as a limiting device 8 of actuating device 1 which is implemented as circuitry, via which power is constantly delivered to driver circuit 4 at micromechanical actuator 2 without influencing the frequency range in which driver circuit control unit 5 is operated.

FIG. 4 shows a schematic block diagram of actuating device 1 for controlling micromechanical actuator 2, together with a cascode current mirror circuit 8c, according to another specific embodiment of the present invention. Cascode current mirror circuit 8c includes an input side having two transistors or metal oxide semiconductor field effect transistors connected in series, and an output side likewise having two transistors or metal oxide semiconductor field effect transistors connected in series. For a simple current mirror as shown in FIG. 4, there is an interfering influence on the dependency of the output current of the current mirror circuit on the control voltage applied to the transistors or metal oxide semiconductor field effect transistors due to the continuous output resistance of the two transistors or metal oxide semiconductor field effect transistors used. This effect may be reduced by cascading the first transistor or the first metal oxide semiconductor field effect transistor on the input side by adding another transistor or metal oxide semiconductor field effect transistor. For precisely setting an operating point of the circuit, a transistor or metal oxide semiconductor field effect transistor is likewise inserted into the current path of the circuit on the output side.

For example, a cascode current mirror circuit 8c having four transistors, four bipolar transistors, or four metal oxide semiconductor field effect transistors 13a, 13b, 13c, 13d is set up in two mirror-symmetrical transistor pairs which include a pair of metal oxide semiconductor field effect transistors 13a, 13b connected in series on the input side, and a pair of metal oxide semiconductor field effect transistors 13c, 13d connected in series on the output side. Corresponding to the circuitry of simple current mirror circuit 8b, also in the case of cascode current mirror circuit 8c the drain and the control electrode are connected to one another and electrically short-circuited on the input side for both metal oxide semiconductor field effect transistors 13a and 13b.

As the result of linking the control electrode connections of oppositely situated metal oxide semiconductor field effect transistors 13a and 13c, and linking metal oxide semiconductor field effect transistors 13b and 13d on the input and output sides of cascode current mirror circuit 8c, the accuracy of the setting of the mirrored current ratio is increased, and therefore, so is the accuracy of the setting of the current of the constant power source, exiting at output 14, which is supplied to micromechanical actuator 2. For example, an internal current source in cascode current mirror circuit 8c is used to supply the input side of cascode current mirror circuit 8c with current. For example, the internal current source thus delivers a reference current via which cascode current mirror circuit 8c diverts an output current which is supplied to power output stage 6 of driver circuit 4 via transistor pair 13c and 13d of current mirror circuit 8c, and via output 14. The reference numerals used in FIG. 4 which have not been mentioned have already been mentioned and described in the description of FIG. 2. A current mirror 8b, 8c may be designed as a simple current mirror circuit 8b or as a cascode current mirror circuit 8c.

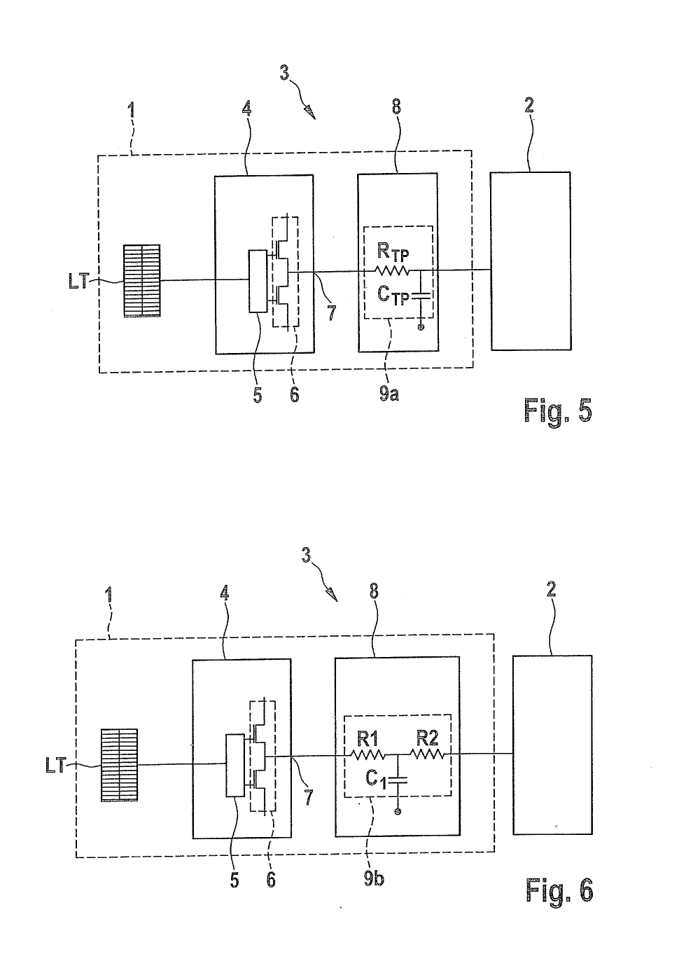

FIG. 5 shows a schematic block diagram of actuating device 1 for controlling a micromechanical actuator 2, together with a first low-pass circuit 9a, according to another specific embodiment of the present invention. Simple low-pass circuit 9a, composed of a resistor-capacitor combination having a resistor R_{TP} and a capacitor C_{TP} in the form of an RC element, represents a first-order Butterworth filter, for example, and is connected as a limiting device 8 between output 7 of driver circuit 4 and micromechanical actuator 2. Ohmic resistor R_{TP} is, for example, a resistor having a nominal value in the range of 1 MΩ-100 MΩ. Ohmic resistor R_{TP} may be an ohmic resistor having a nominal value in the range of 1 MΩ-3 MΩ. Capacitor C_{TP} is, for example, a capacitor having a nominal value in the range of 1 pF-1000 pF. Capacitor C_{TP} may be a capacitor having a nominal value in the range of approximately 10 pF. For example, the nominal values of components C_{TP} and R_{TP} are specified by a desired limiting frequency of the low-pass circuit, the desired limiting frequency being, for example, in a higher frequency range than second frequency component f_{fast}. The reference numerals used in FIG. 5 which have not been mentioned have already been mentioned and described in the description of FIG. 2.

FIG. 6 shows a schematic block diagram of actuating device 1 for controlling a micromechanical actuator 2, together with a second low-pass circuit 9b, according to another specific embodiment of the present invention. In second low-pass circuit 9b, a simple low-pass circuit composed of a resistor-capacitor combination (RC element) of a resistor R1 and a capacitor C₁ is supplemented by a resistor R2 connected downstream. Second low-pass circuit 9b is used as limiting device 8 between output 7 of driver circuit 4 and micromechanical actuator 2. Ohmic resistor R1 is, for example, a resistor having a nominal value in the range of 1 MΩ-100 MΩ. Ohmic resistor R1 may be an ohmic resistor having a nominal value in the range of 1 MΩ-3 MΩ. Capacitor C₁ is, for example, a capacitor having a nominal value in the range of 1 pF-1000 pF. Capacitor C₁ may be a capacitor having a nominal value in the range of approximately 10 pF. Ohmic resistor R2 is, for example, a resistor having a nominal value in the range of 1 kΩ-1000 kΩ. Ohmic resistor R2 may be an ohmic resistor having a nominal value in the range of 100 kΩ-500 kΩ. For example, the nominal values of components C₁ and R1 are specified by a desired limiting frequency of the low-pass circuit, the desired limiting frequency for example being in a higher frequency range than second frequency component f_{fast}. The reference numerals used in FIG. 6 which have not been mentioned have already been mentioned and described in the description of FIG. 2.

FIG. 7 shows the design of an equivalent circuit diagram of micromechanical actuator 2 as an example. The equivalent circuit diagram describes the electrical response of micromechanical actuator 2 with the aid of virtual electronic components. A micromechanical actuator 2 of an MEMS, which is electronically controlled by an actuating device 1a via a feed line, may be described, for example, as a parallel circuit composed of a high-resistance resistor R_{actuator}, a capacitor C_{actuator P}, and a capacitor C_{actuator N}. A series resistor Rₗᵢₙₑ represents line resistances of the feed line which occur, and is usually low-resistance. Parasitic capacitor C_{actuator P} and useful capacitor C_{actuator N} may be combined into an overall capacitor C_{actuator}. Useful capacitor C_{actuator N}, which is directly related to the mechanical deflection of micromechanical actuator 2, is often small compared to parasitic capacitor C_{actuator P .}

FIG. 8 shows a function graph of a signal shape US for controlling a micromechanical actuator 2 according to another specific embodiment of the present invention. Time, as indicated by 1/f_{slow}, is plotted on the abscissa axis. The voltage applied to micromechanical actuator 2 is plotted on the ordinate axis. The function graph illustrates the functional relationship between the two variables time and voltage, and shows signal shape US in the case of a first value of a limitation by limiting device 8 as a variation over time. The voltage excursion which appears in signal shape US and which is continuously present at micromechanical actuator 2 is described by variable ΔU_{c}.

FIG. 9 shows a function graph of a signal shape US for controlling a micromechanical actuator 2 according to another specific embodiment of the present invention. Time, as indicated by 1/f_{slow}, is plotted on the abscissa axis. The voltage applied to micromechanical actuator 2 is plotted on the ordinate axis. The function graph shows signal shape US in the case of a second value of the limitation by limiting device 8 as a variation over time, the damping of voltage excursion ΔU_{c} by the second value of the voltage limitation being greater than the damping of voltage excursion ΔU_{c} by the first value of the voltage limitation.

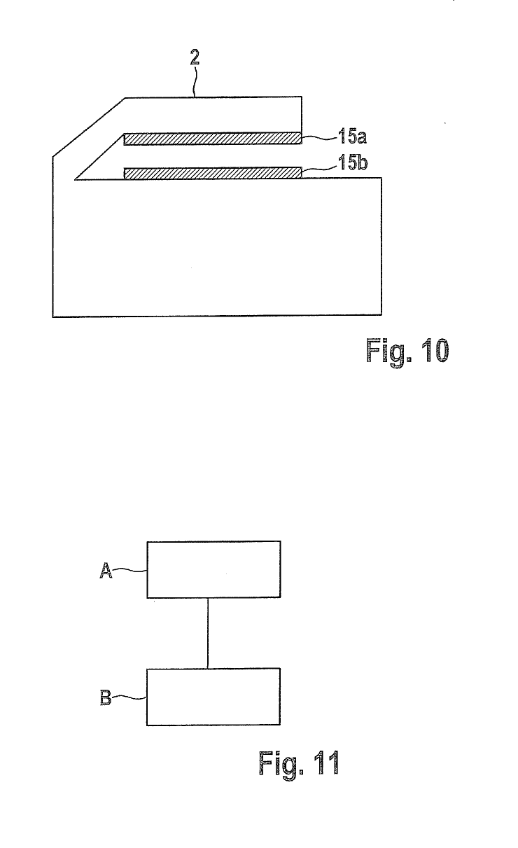

FIG. 10 shows a cross section of an electrostatically excitable micromechanical actuator 2 according to another specific embodiment of the present invention. Micromechanical actuator 2 is formed, for example, in a design based on a tongue anchored on a substrate or on a wafer. The design allows the tongue to change shape only by bending. In addition, the design may also be implemented as the arrangement of two parallel plates spaced only a few microns apart, one of the plates being fixedly locked and the other plate being bendably or flexibly supported. The flexible tongue is pulled from the rigid electrode mounted on the substrate by applying a voltage to the two metal electrodes 15a, 15b. The micromechanical tongue is thus deflected corresponding to the applied voltage.

FIG. 11 shows a flow chart of a method for controlling a micromechanical actuator 2 according to another specific embodiment of the present invention. The method includes outputting A of signal shapes US to the rechargeable capacitor of micromechanical actuator 2, and limiting B power consumption of micromechanical actuator 2 by limiting the current and/or voltage of output signal shapes US.

What is claimed is:

1. An actuating device for controlling a micromechanical actuator, which has a rechargeable capacitor for generating a mechanical motion of the micromechanical actuator, comprising:
a memory having a lookup table containing previously computed data of signal shapes for controlling the micromechanical actuator;
a driver circuit having a driver circuit control unit for processing the previously computed data, a power stage for generating the signal shapes, and an output for outputting the signal shapes, corresponding to the previously computed data, to the rechargeable capacitor of the micromechanical actuator; and
a limiting device, situated between the output of the driver circuit and the micromechanical actuator, which is configured for limiting a voltage excursion of the signal shapes output by the driver circuit, which are usable for generating the mechanical motion by recharging the rechargeable capacitor of the micromechanical actuator, the power consumption of the micromechanical actuator being reducible by limiting the voltage excursion.

2. The actuating device of claim 1, wherein the limiting device includes at least one ohmic resistor connected in series.

3. The actuating device of claim 1, wherein the limiting device includes a current mirror of the driver circuit.

4. The actuating device of claim 1, wherein the limiting device includes a low-pass filter.

5. The actuating device of claim 1, wherein the limiting device is configured for limiting a voltage of the signal shapes applied to the micromechanical actuator.

6. The actuating device of claim 1, wherein the limiting device is configured for limiting a current of the signal shapes applied to the micromechanical actuator.

7. The actuating device of claim 1, wherein the driver circuit has a pulse width modulation device which generates a pulse width modulation signal for controlling the micromechanical actuator.

8. The actuating device of claim 7, wherein the pulse width modulation device of the driver circuit is configured in a frequency range which is much higher than frequencies of mechanical resonances of the micromechanical actuator, so that inertia of the micromechanical actuator prevents mechanical motions of the micromechanical actuator in the frequency range of the pulse width modulation.

9. A microsystem device, which includes a micromechanical actuator, which has a rechargeable capacitor for generating a mechanical motion of the micromechanical actuator, comprising:
a memory having a lookup table containing previously computed data of signal shapes for controlling the micromechanical actuator;
a driver circuit having a driver circuit control unit for processing the previously computed data, a power stage for generating the signal shapes, and an output for outputting the signal shapes, corresponding to the previously computed data, to the rechargeable capacitor of the micromechanical actuator; and
a limiting device, situated between the output of the driver circuit and the micromechanical actuator, which is configured for limiting a voltage excursion of the signal shapes output by the driver circuit, which are usable for generating the mechanical motion by recharging the rechargeable capacitor of the micromechanical actuator, the power consumption of the micromechanical actuator being reducible by limiting the voltage excursion.

10. A method for controlling a micromechanical actuator, which has a rechargeable capacitor for generating a mechanical motion of the micromechanical actuator, the method comprising:
outputting signal shapes to the rechargeable capacitor of the micromechanical actuator, using a driver circuit for controlling the micromechanical actuator, which has a memory having a lookup table containing previously computed data of signal shapes for controlling the micromechanical actuator, and using a driver circuit control unit, a power stage for generating the signal shapes, and an output for outputting the signal shapes, corresponding to the previously computed data, to the rechargeable capacitor of the micromechanical actuator; and
limiting power consumption of the micromechanical actuator, using a limiting device, which is situated between the output of the driver circuit and the micromechanical actuator, limiting a voltage excursion of the signal shapes output by the driver circuit, wherein the signal shapes are used for generating the mechanical motion by recharging the rechargeable capacitor of the micromechanical actuator.

11. The method of claim 10, wherein the driver circuit is controlled by pulse width modulation for controlling the micromechanical actuator.

12. The method of claim 10, wherein the pulse width modulation device of the driver circuit is operated in a frequency range which is much higher than frequencies of mechanical resonances of the micromechanical actuator, so that inertia of the micromechanical actuator prevents mechanical motions of the micromechanical actuator in the frequency range of the pulse width modulation.
